(19) United States
(12) Patent Application Publication
(10) Pub. No.: US 2007/0057891 A1
(43) Pub. Date: Mar. 15, 2007

(54) METHOD FOR THE TRANSITION OF LIQUID CRYSTAL DISPLAY

(76) Inventors: Jung-Chieh Cheng, Changhua County (TW); Chao-Dong Syu, Miaoli County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,409

(22) Filed: Sep. 9, 2005

(51) Int. Cl. G09G 3/36

(52) U.S. Cl. 345/94

(57) ABSTRACT

A method for the transition of a liquid crystal display is provided. The liquid crystal display includes a liquid crystal panel including a first electrode, a second electrode and a vertical alignment liquid crystal layer between the first and second electrodes. The method includes performing a pre-driving step including applying a reference voltage on the first electrode and applying a driving voltage on the second electrode so as to form an electric field between the first and second electrodes, wherein the frequency of the driving voltage is a voltage level variation frequency.

### BACKGROUND OF THE INVENTION

1. Field of the Invention

The present invention generally relates to a method for the transition of a liquid crystal display (LCD). More particularly, the present invention relates to a method for the transition of an optical compensated birefringence (OCB) liquid crystal display.

2. Description of Related Art

Liquid crystal displays are divided into various types in accordance with liquid crystal molecule, driving method and light source arrangement. The optical compensated birefringence liquid crystal display (OCB LCD) has an advantage of fast response so as to provide good displaying quality especially when displaying a movie or animated cartoon. However, the OCB liquid crystal molecules of the OCB LCD should first be transited into a bend state from a splay state to be in a stand-by state, and thus the OCB LCD can show fast response characteristic.

FIG. 1A is a diagram showing OCB liquid crystal molecules in a splay state. Fib. 1B is a diagram showing OCB liquid crystal molecules in a bend state. As shown in FIG. 1A and FIG. 1B, the conventional OCB LCD 100 has OCB liquid crystal molecules 130 therein which are disposed between a color filter substrate 110 and a thin film transistor array substrate 120. The color filter substrate 110 has a common electrode 112 thereon while the thin film transistor array substrate 120 has a plurality of pixel electrodes 122 (only one pixel electrode is shown in the drawing) thereon. In FIG. 1A, when no voltage is applied on the common electrode 112 and the pixel electrode 122, the OCB liquid crystal molecules 130 are arranged as a splay state because no electric field is formed to act on the OCB liquid crystal molecules 130. In FIG. 1B, when a voltage is applied between the common electrode 112 and the pixel electrode 122, the OCB liquid crystal molecules 130 are transited into a bend state because a transition electric filed E is formed between the color filter substrate 110 and the thin film transistor array substrate 120, and then the OCB LCD 100 is in a stand-by state.

However, in the conventional OCB LCD 100, the transition procedure for several minutes is needed before operating the pixels of the OCB LCD 100. That is, a long warm up time is required before the OCB LCD 100 gets into a stand-by state. The conventional OCB LCD 100 fails to meet the requirement of turn on and play. Therefore, fast transition for an OCB LCD is required.

The conventional methods for resolving the above problem are as follows. In one of the convention methods, a high voltage is applied between the color filter substrate 110 and the thin film transistor array substrate 120, as shown in FIG. 1B. When a high transition electric field acts on the OCB liquid crystal molecules 130, the OCB liquid crystal molecules 130 can be transited into a bend state from a splay state quickly. However, only a few of source integrated circuits (ICs) can be used for this high voltage driving method, and this method is high power consuming.

Another conventional method is adding a polymer into the OCB liquid crystal layer to increase a pre-tilt angle of the OCB liquid crystal molecules. The polymer is a compound that is reactive when irradiated under ultraviolet (UV) light. The pre-tilt angle is a tilt angle between a major axis of the liquid crystal molecules and a direction of the electric field. If the liquid crystal molecules have a higher pre-tilt angle, the transition time of the OCB liquid crystal molecules can be reduced. However, the process of adding the polymer into the OCB liquid crystal layer is more complex, and it may deteriorate process yield.

The other conventional method is designing specific pixel structures, wherein a bending electric field is formed at a predetermined region because of the specific pixel structures, and thus the transition time of the OCB liquid crystal molecules can be reduced. In details, silts or protrusions are formed on the pixel electrodes or common electrode. A bending electric field will be formed at the region that the silts or protrusions formed, and the transition time of the OCB liquid crystal molecules can be reduced because of the bending electric field. However, the manufacturing process for the pixel structures is also more complex.

### SUMMARY OF THE INVENTION

Accordingly, the present invention is directed to a method for the transition of a liquid crystal display capable of fast transiting OCB liquid crystal molecules into a bending state from a splay state to shorten the warm up time of the OCB LCD by using a driving voltage having low frequency and/or low voltage to drive.

According to an embodiment of the present invention, a method for the transition of a liquid crystal display is provided. The liquid crystal display comprises a liquid crystal panel including a first electrode, a second electrode and a vertical alignment liquid crystal layer between the first and second electrodes. The method comprises performing a pre-driving step comprising applying a reference voltage on the first electrode and applying a driving voltage on the second electrode so as to form an electric field between the first and second electrodes, wherein the frequency of the driving voltage is a voltage level variation frequency

According to an embodiment of the present invention, said frequency of the driving voltage is not larger than 50 Hz.

According to an embodiment of the present invention, said frequency of the driving voltage is between 0.2˜50 Hz.

According to an embodiment of the present invention, said driving voltage includes a first voltage level and a second voltage level, and the driving voltage is varied between the first and second voltage levels, wherein the difference between the first and second voltage levels is not larger than 30V.

According to an embodiment of the present invention, said driving voltage is a voltage of square-wave pulse.

According to an embodiment of the present invention, said driving voltage is a voltage of triangle-wave pulse.

According to an embodiment of the present invention, said driving voltage is a voltage of sine-wave pulse.

According to an embodiment of the present invention, the reference voltage is a direct voltage.

According to an embodiment of the present invention, the reference voltage is between 0˜10V.

According to an embodiment of the present invention, the difference between the driving voltage and the reference voltage is not larger than 30V.

According to an embodiment of the present invention, the method further comprising performing a displaying step to provide an image signal to the liquid crystal display so as to display an image on the liquid crystal panel in accordance with the image signal.

According to an embodiment of the present invention, the liquid crystal display further comprises a backlight module, and the backlight module is turned on when performing the displaying step.

According to an embodiment of the present invention, the liquid crystal display is an optical compensated birefringence liquid crystal display.

According to an embodiment of the present invention, the liquid crystal panel comprises a color filter substrate and a thin film transistor array substrate, and the first electrode is disposed over the color filter substrate and the second electrode is disposed over the thin film transistor array substrate. The first electrode is a common electrode. The second electrode comprises a plurality of pixel electrodes.

In the present invention, the driving voltage having low frequency and/or low voltage is used in the pre-driving step so that the OCB liquid crystal layer between the first and electrodes can fast transited into a bend state from a splay state so as to reduce the warm up time for the LCD.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a diagram showing OCB liquid crystal molecules in a splay state.

FIG. 1B is a diagram showing OCB liquid crystal molecules in a bend state.

FIG. 2 is a cross-section view showing an OCB LCD according to an embodiment of the present invention.

FIG. 3 is a flowchart showing a method for the transition of an OCB LCD according to an embodiment of the present invention.

FIGS. 4˜6 are drawings showing relationships between driving voltages and turn-on times of an OCB LCD and a backlight module.

FIG. 7 is a circuit diagram showing an OCB LCD according to an embodiment of the present invention.

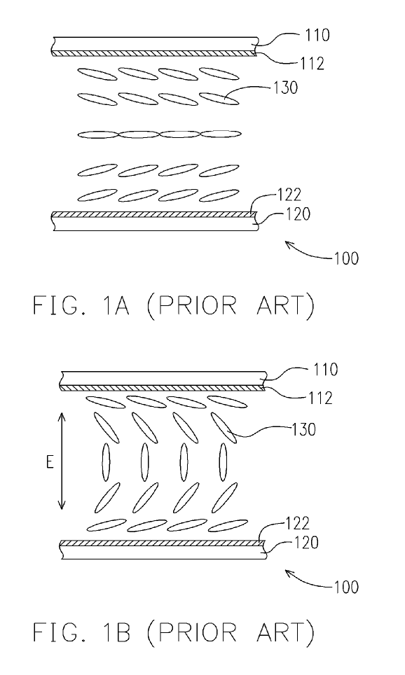

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the present invention, a transition electric field generated from a driving voltage having low frequency and/or low voltage is formed so that the OCB liquid crystal layer can be fast transited into a bend state from a splay state so as to reduce the warm up time for the LCD. The detail description is as follows but not limited to the present invention. It will be apparent to those skilled in the art that various modifications and variations can be made to the structure of the present invention without departing from the scope or spirit of the invention.

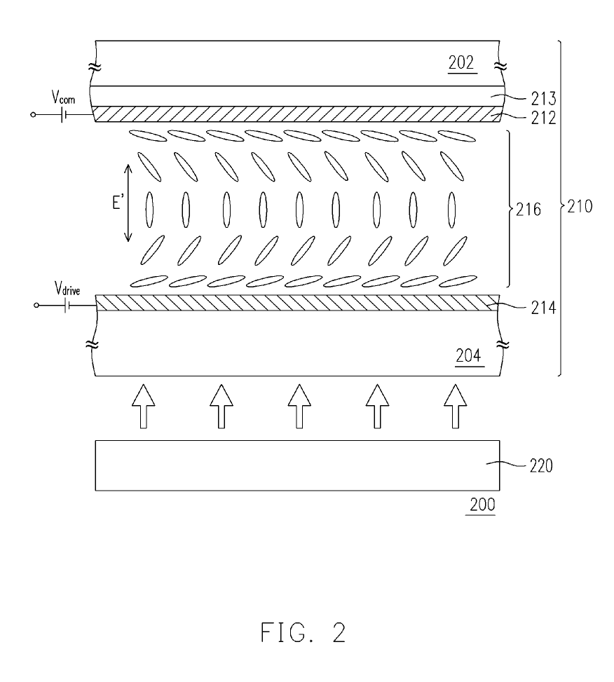

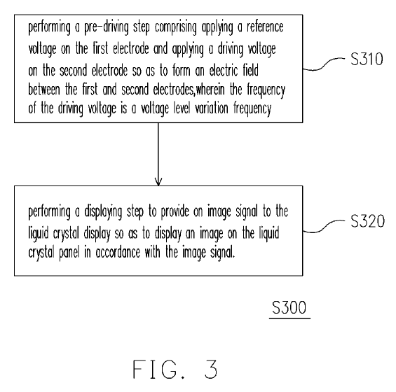

FIG. 2 is a cross-section view showing an OCB LCD according to an embodiment of the present invention. As shown in FIG. 2, the liquid crystal display 200 comprises a liquid crystal panel 210 including a first electrode 212, a second electrode 214 and an OCB liquid crystal layer 216 between the first and second electrodes 212, 214. The first electrode 212 is formed on a substrate 202, and the second electrode 214 is formed on another substrate 204. The substrate 202 is a color filter substrate, for example. The substrate 204 is a thin film transistor array substrate, for example. In an embodiment, the first electrode 212 is a common electrode while the second electrode 214 comprises pixel electrodes (only one pixel electrode is shown in the drawing) if the LCD is an active matrix LCD, and each pixel electrode 214 is further electrically connected to an active device (such as a thin film transistor). In another embodiment, a color filter layer 213 is further formed between the substrate 202 and the first electrode 212. According to another embodiment of the present invention, the OCB LCD further comprises a backlight module 220 disposed under the LC panel 210 to provide surface light for displaying.

FIG. 3 is a flowchart showing a method for the transition of an OCB LCD according to an embodiment of the present invention. Please refer to FIG. 2 and FIG. 3, the method S300 comprises performing a pre-driving step S310 that is applying a reference voltage (V_{com}) on the first electrode 212 and applying a driving voltage (V_{drive}) on the second electrode 214 so as to form a transition electric field E′ between the first and second electrodes 212, 214, wherein the frequency of the driving voltage (V_{drive}) is a voltage level variation frequency. In an embodiment, the frequency of the driving voltage (V_{drive}) is not larger than 50 Hz. Preferably, the frequency of the driving voltage (V_{drive}) is between 0.2˜50 Hz. In addition, the method S300 further comprises performing a displaying step S230 to provide an image signal to the liquid crystal display 200 so as to display an image on the liquid crystal panel 210 in accordance with the image signal. In an embodiment, when the displaying step S320 is conducted, further comprising turning on the backlight module 200 so as to provide a surface light to the liquid crystal panel 210.

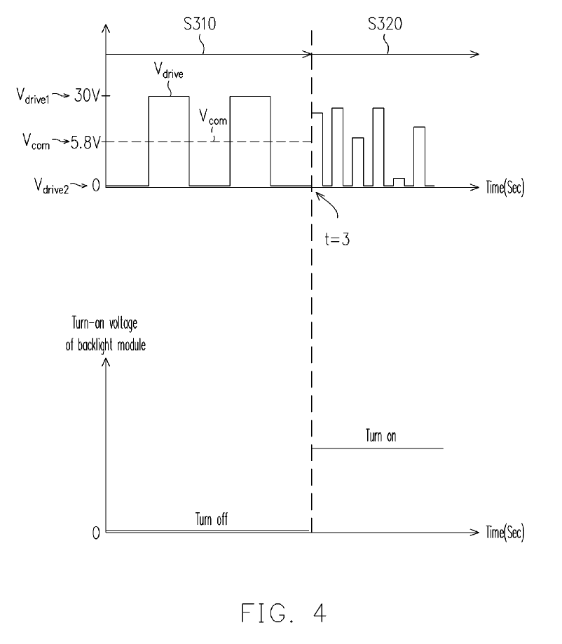

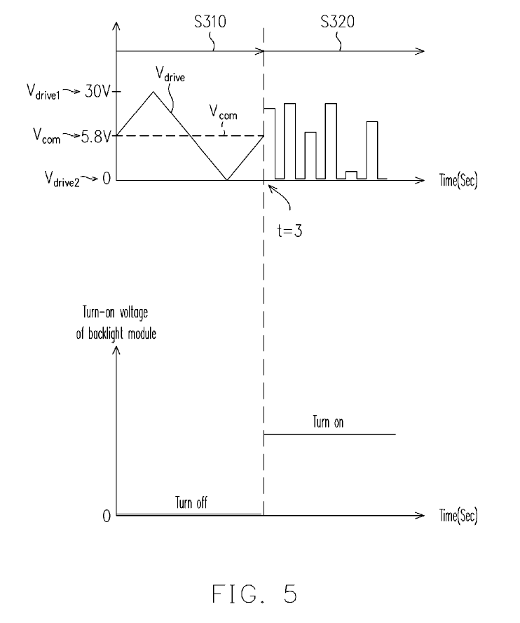

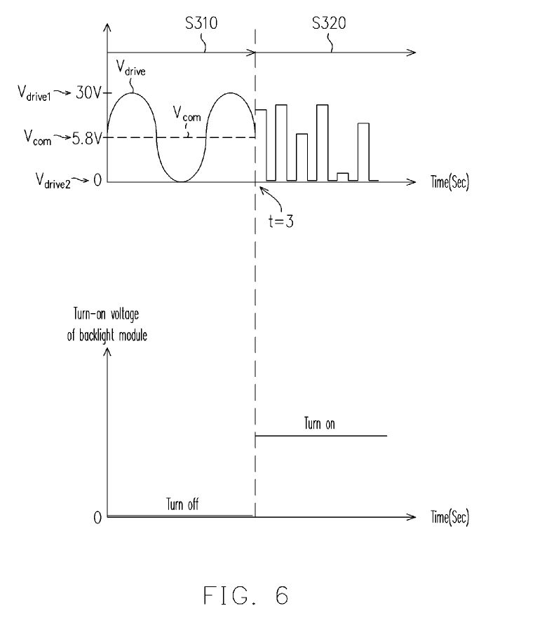

In particular, various methods can be used to form the transition electric field E′ described as follows. FIGS. 4˜6 are drawings showing relationships between driving voltages and turn-on times of an OCB LCD and a backlight module. As shown in FIG. 4, the driving voltage V_{drive} can be a voltage of square-wave pulse in an embodiment. When the pre-driving step S310 is conducted, the driving voltage V_{drive} is applied, wherein the driving voltage V_{drive} has a first voltage level V_{drive1} and a second voltage level V_{drive2} and the driving voltage V_{drive} is varied between the first and second voltage levels V_{drive1}, V_{drive2}. The difference between the first and second voltage levels V_{drive1}, V_{drive2} is, for example, not larger than 30V. The frequency of the driving voltage V_{drive} is not larger than 50 Hz. Hence, the LCD 200 is driven under a low frequency condition. In a preferred embodiment, the frequency of the driving voltage V_{drive} is, for example, between 0.2 Hz and 50 Hz so that the OCB liquid crystal layer 216 can be fast transited into a bend state from a splay state.

As shown in FIG. 2 and FIG. 4, the reference voltage V_{com} is a direct voltage and is constant. In an embodiment, the reference voltage V_{com} is between 0V and 10V, for example, and preferably is at 5.8V. It should be noted that the difference between the driving voltage V_{drive} and the reference voltage V_{com} is smaller than or equal to 30V. That is the LCD 200 is driven under a low voltage condition.

For the foregoing, the OCB liquid crystal layer 216 is driven under the low frequency condition and/or the low voltage condition so that the OCB liquid crystal layer 206 can be fast transited into a bend state form a splay state. Therefore, the warm up time for the LCD 200 can be reduced to 1˜3 seconds.

In another embodiment of the present invention, the driving voltage V_{drive} can be a voltage of triangle-wave pulse, as shown in FIG. 5. Alternatively, the driving voltage V_{drive} can also be a voltage of sine-wave pulse, as shown in FIG. 6. In order to reducing the driving power of the LCD 200, when the LCD 200 is turned on for pre-driving in t seconds, the backlight module 220 (as shown in FIGS. 4-6) is still in a turn off state. After the pre-driving step, the image signal is input into the LCD 200. At this time, the backlight module 220 is turned on to display an image on the liquid crystal panel 210. In an embodiment, the time t for pre-driving is 1˜3 seconds, for example.

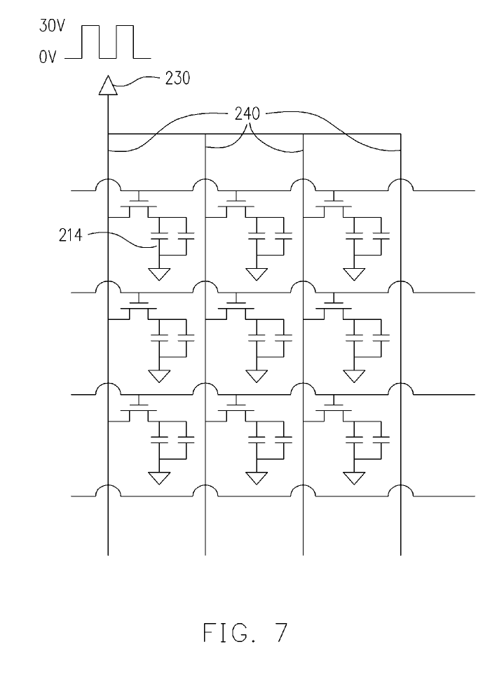

FIG. 7 is a circuit diagram showing an OCB LCD according to an embodiment of the present invention. In the embodiment, the OCB LCD is an active matrix LCD. Please refer to FIG. 2 and FIG. 7, the LCD 200 further comprises a gamma circuit 230 (shown in FIG. 7). When the driving voltage V_{drive} is applied on the pixel electrode 214, a plurality of data lines 240 electrically connected to the pixel electrodes 214 are electrically connected to each other through the gamma circuit 230 so that the driving voltages V_{drive} applied on all the pixel electrodes 214 are the same. Therefore, all the liquid crystal molecules of the OCB liquid crystal layer 216 are fast transited into a bend state from a splay state because of the transition electric field E′ generated from the driving voltage V_{drive} having low frequency and/or low voltage.

Accordingly, the method for driving a LCD has advantages as follows:

In the present invention, a driving voltage having low frequency and/or low voltage is applied on the pixel electrode so as to form a transition electric field between the pixel electrode and the common electrode. The OCB liquid crystal layer can be fast transited into a bend state from a splay state, and thus the warm up time for the LCD can be reduced.

In addition, the backlight module is turned on after the transition procedure of the OCB liquid crystal layer is completed. Hence, the power consuming of the LCD can be reduced.

Moreover, because the low driving voltage is applied in the method, it can meet the requirement of the current driving ICs. Therefore, various current driving ICs can be used in the present invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for the transition of a liquid crystal display comprising a liquid crystal panel including a first electrode, a second electrode and an optical compensated birefringence (OCB) liquid crystal layer between the first and second electrodes, the method comprising:
performing a pre-driving step comprising applying a reference voltage on the first electrode and applying a driving voltage on the second electrode so as to form an electric field between the first and second electrodes, wherein the frequency of the driving voltage is a voltage level variation frequency.

2. The method according to claim 1, wherein the frequency of the driving voltage is not larger than 50 Hz.

3. The method according to claim 1, wherein the frequency of the driving voltage is between 0.2˜50 Hz.

4. The method according to claim 1, wherein the driving voltage includes a first voltage level and a second voltage level, and the driving voltage is varied between the first and second voltage levels, wherein the difference between the first and second voltage levels is not larger than 30V.

5. The method according to claim 1, wherein the driving voltage is a voltage of square-wave pulse.

6. The method according to claim 1, wherein the driving voltage is a voltage of triangle-wave pulse.

7. The method according to claim 1, wherein the driving voltage is a voltage of sine-wave pulse.

8. The method according to claim 1, wherein the reference voltage is a direct voltage.

9. The method according to claim 1, wherein the reference voltage is between 0˜10V.

10. The method according to claim 1, wherein the difference between the driving voltage and the reference voltage is equal to or not larger than 30V.

11. The method according to claim 1, further comprising performing a displaying step to provide an image signal to the liquid crystal display so as to display an image on the liquid crystal panel in accordance with the image signal.

12. The method according to claim 11, wherein the liquid crystal display further comprises a backlight module, and the backlight module is turned on when performing the displaying step.

13. The method according to claim 1, wherein the liquid crystal display is an optical compensated birefringence liquid crystal display.

14. The method according to claim 1, wherein the liquid crystal panel comprises a color filter substrate and a thin film transistor array substrate, and the first electrode is disposed over the color filter substrate and the second electrode is disposed over the thin film transistor array substrate.

15. The method according to claim 14, wherein the first electrode is a common electrode.

16. The method according to claim 14, wherein the second electrode comprises a plurality of pixel electrodes.
